(19) United States
(12) Patent Application Publication
(10) Pub. No.: US 2012/0231416 A1
(43) Pub. Date: Sep. 13, 2012

(54) PERIODONTAL SCALER AND PLANER COMBINED INSTRUMENT

(75) Inventors: Susan J. Drapeau, Cordova, TN (US); Kelly Brook Emerton, Memphis, TN (US); Daniel Andrew Shimko, Germantown, TN (US)

(73) Assignee: WARSAW ORTHOPEDIC, INC., Warsaw, IN (US)

(21) Appl. No.: 13/043,996

(22) Filed: Mar. 9, 2011

(51) Int. Cl. A61C 17/20; A41D 13/04; A61C 17/00

(52) U.S. Cl. 433/119; 433/143; 2/48

(57) ABSTRACT

Provided is a periodontal instrument adapted for use in debridement of a root surface of a tooth having an axially elongated shaft and a shank. The shank is disposed at an end of the shaft and has a body extending distally relative to the shaft. The body includes a plurality of blades adapted for use in debridement of a root surface. Each blade is configured for scaling and/or planning of a root surface and the shaft is dimensioned and configured to facilitate manual manipulation of the shank. Also provided is a removable tip periodontal instrument adapted for use in debridement of a root surface of a tooth and a kit including a device and a plurality of tips that may be color coded for easy reference by the clinician.

### TECHNICAL FIELD

The present disclosure generally relates to periodontal instruments, and more particularly to periodontal instruments such as scalers and planers used in debridement of root surfaces of a tooth.

### BACKGROUND

Conventional periodontal therapy, also known as non-surgical periodontal therapy, is the most common and conservative form of treatment for periodontal (gum) disease. An important objective of such therapy is to remove or eliminate the etiologic agents that cause inflammation, dental plaque and its products, and calculus, thus helping to establish a periontium that is free of disease. Such therapy may include the use of both scaling and planing procedures to accomplish debridement of the root surface of a given tooth below the gumline.

Scaling is a somewhat coarse procedure by which most of the overall volume of deposits on the root surface below the gumline is removed. Such deposits may include plaque, tartar, cementum, and dentin that is rough or permeated by calculus. When performing scaling procedures below the gumline, clinicians typically use rather heavy gage periodontal instruments equipped with blunt or rounded ends (to protect the soft tissue of the gums) and strong, often rather rugged blades featuring sharp cutting edges in order to break up, dig out, and/or scrape away such deposits in bulk. By comparison, root planing is a relatively fine procedure by which the smaller part of the overall volume of deposits typically left behind on the root surface after the initial scaling procedure is complete is removed. When performing root planing, clinicians typically use somewhat lighter gage periodontal instruments, such as thin curettes, equipped with relatively fine, often razor-like blades featuring very sharp cutting edges to shave (or ‘plane’) away the remaining deposits down to the bare surface of the root, or to smooth the root surfaces by removing any infected tooth structure. Root planing performed after scaling can result in the gum tissue more firmly reattaching to the root surface that are clean and smooth, thereby reducing the likelihood of tooth loss and sensitivity problems. The root planing procedure also makes it more difficult for plaque to accumulate along the surface of the root in the days and weeks after the root surface debridement treatment is complete. As such, clinicians who take the extra time to accomplish root planing immediately after scaling can bring about quicker healing, and more effectively facilitate subsequent re-attachment of the gum tissue to the root surface, than clinicians who perform periodontal therapies in which scaling alone is used.

In order to perform conventional periodontal therapy, clinicians have at their disposal a wide variety of instruments, including ultrasonic tools, as well as manual or hand instruments. Before the advent of ultrasonic scaling, moderate to advanced gum disease was typically treated only by means of surgery. With the current broad availability of ultrasonic scaling, however, most calculus deposits appearing on root surfaces can be removed without surgery. The setup for ultrasonic scaling typically includes a hand piece with a small scaling tip. Used in combination with a water flow, the soft or low amplitude ultrasonic vibration transmitted by the hand piece to the root surface via the scaling tip can quickly and effectively remove most moderate to large-scale calculus deposits.

Whether an ultrasonic scaling hand piece is used for root surface debridement, or traditional manual instruments are used, dental and periodontal clinicians typically place a high value on speed and efficiency. The clinician may prefer or be required to use many different debridement instruments featuring differently configured respective working tips due to differences in anatomical geometry. Such differences may arise, for example, based on whether the root surface being scaled or planed is that of an incisor, a canine, a premolar, or a molar. Such differences may also arise based on whether the root surface being scaled or planed is one or another root surface of the same tooth. Time spent deciding which periodontal instrument to use next, and on actually switching from instrument to instrument, or from working tip to working tip (e.g., during ultrasonic scaling), can add up during a given procedure, lengthening the time for treatment or causing delays which patients and clinicians would prefer to avoid if possible. Accordingly, a current need exists for innovative periodontal tools, instruments, and root surface debridement kits that provide the clinician with greater utility and ease of use.

### SUMMARY OF THE INVENTION

Accordingly, periodontal instruments, periodontal tools, working tips for periodontal instruments, and periodontal treatment kits for root surface debridement, as well as tooth maps and clinician gowns are disclosed that provide the clinician with greater utility and ease of use.

In one particular embodiment, in accordance with the principles of the present disclosure, a periodontal instrument is provided. The periodontal instrument is configured for use in debridement of a root surface of a tooth and comprises an axially elongated shaft and a shank disposed at an end of the shaft. The shank having a body extending distally relative to the shaft. The body includes a plurality of blades adapted for use in debridement of a root surface. The plurality of blades includes at least a first blade configured for scaling of a root surface, and a second blade configured for planing of a root surface. The shaft is dimensioned and configured to facilitate manual manipulation of the shank.

In one particular embodiment, in accordance with the principles of the present disclosure, a periodontal tool having a plurality of periodontal instruments is provided. The periodontal tool is adapted to facilitate debridement of a variety of different types of root surfaces and comprises one or more walls configured to define a housing configured to house the plurality of periodontal instruments therein. Each periodontal instrument includes an axially elongated shaft and a shank disposed at an end of the shaft that extends distally relative thereto. The shank defines a plurality of blades adapted for use in debridement of a root surface. The plurality of blades including at least a first blade configured for scaling of a root surface and a second blade configured for planing of a root surface, wherein the respective shanks of the periodontal instruments have different configurations from each other so as to facilitate debridement of different types of root surfaces. In particular, the different configurations are designed to facilitate planning and/or scaling of root surfaces selected from the group comprising an incisor root surface, a canine root surface, a premolar root surface, and a molar root surface.

In one particular embodiment of the present invention, a periodontal instrument having removable working tips is provided. The working tip is adapted for use in debridement of a root surface of a tooth and comprises a releasable coupling abutment configured so that the working tip is attachable to a handle of the periodontal instrument and a shank disposed at an end of the coupling abutment. The shank includes a body extending distally relative to the coupling abutment. The body defining a plurality of blades adapted for use in debridement of a root surface. The plurality of blades includes at least a first blade configured for scaling a root surface, and a second blade configured for planing a root surface.

In one particular embodiment a periodontal treatment kit is provided. The periodontal treatment kit is equipped and configured for use by a clinician in debridement of a root surface of a tooth and comprises at least two working tips further described herein. The respective shanks of the working tips are configured differently from each other so as to facilitate debridement of different types of root surfaces. The root surfaces in which the working tips are configured to work on are selected from the group comprising an incisor root surface, a canine root surface, a premolar root surface, and a molar root surface.

More details of these embodiments and others of the present invention are described in greater details in the sections below.

### BRIEF DESCRIPTION OF THE DRAWINGS

The present disclosure will become more readily apparent from the specific description accompanied by the following drawings, in which:

FIG. 1 is a side elevational view of an embodiment of a periodontal instrument in accordance with the principles of the present disclosure;

FIG. 2 is a side elevational view of another embodiment of a periodontal instrument in accordance with the principles of the present disclosure;

FIG. 3 is a side elevational view of an embodiment of a periodontal tool in accordance with the principles of the present disclosure;

FIG. 4 is a side elevational view of another embodiment of a periodontal tool in accordance with the principles of the present disclosure

FIG. 5 is a side elevational view of an embodiment of a working tip for a periodontal instrument in accordance with the principles of the present disclosure;

FIG. 6 is a plan view of a color-coded tooth map in accordance with the principles of the present disclosure;

FIG. 7 is a plan view of a periodontal treatment kit in accordance with the principles of the present disclosure; and

FIG. 8 is a side elevational view of a further periodontal tool in accordance with the principles of the present disclosure.

Like numerals appearing in the tens and units digits of reference numerals differing only in the hundreds digit indicate the same or similar parts throughout the figures.

Like reference numerals indicate the same or similar parts throughout the figures.

### DETAILED DESCRIPTION OF THE INVENTION

The exemplary embodiments of the instruments, working tips, and treatment kits are discussed in terms of periodontal instruments, and more particularly, in terms of periodontal instruments for use in debridement of root surfaces. It is envisioned that at least some of the periodontal instruments, working tips, and treatment kits may be operated manually, including via the use of a manually graspable elongated handle, or with the assistance of ultrasonic power, including via the use of an ultrasonic hand piece equipped with an embodiment of a working tip in accordance with the principles of the present disclosure.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, left and right, are for illustrative purposes only and can be varied within the scope of the disclosure. For example, the references “upper” and “lower” are relative and used only in the context to the other, and are not necessarily “superior” and “inferior”.

Scaling and root planing is the most common and conservative form of treatment for periodontal (gum) disease. The objective of scaling and root planing, otherwise known as conventional periodontal therapy or non-surgical periodontal therapy, is to remove or eliminate the etiologic agents which cause inflammation: dental plaque, its products and calculus, thus helping to establish a periodontum that is free of disease. In order to perform this procedure, clinicians typically use a combination of ultrasonic scalers and hand instruments. This disclosure describes, for example, a dual faceted dental surgical instrument that combines scaling and planing into one handy periodontal instrument. This instrument has much utility in the dental arena as it combines multiple instruments, featuring a modified surface for greater utility and ease of use for the clinician.

The following discussion includes a description of particular examples of periodontal instruments, periodontal tools, working tips for periodontal instruments, tooth maps, and periodontal treatment kits in accordance with the principles of the present disclosure. Alternate embodiments are also disclosed.

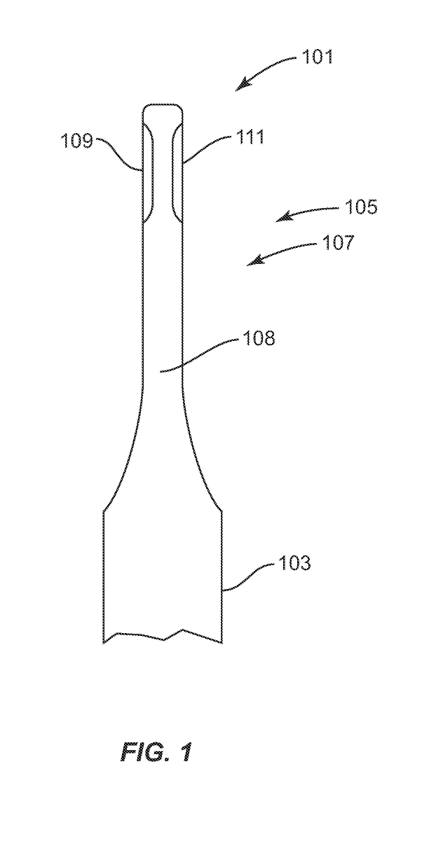

Reference will now be made in detail to the exemplary embodiments of the present disclosure, which are illustrated in the accompanying figures. Turning now to FIG. 1, part of a periodontal instrument 101 in accordance with embodiments of the present disclosure is shown. The instrument 101 is adapted for use in debridement of a root surface of a tooth. The instrument 101 includes a shaft 103 and a working tip 105 disposed at an end of the shaft 103. The shaft 103 is dimensioned and configured to facilitate manual manipulation of the working tip 105 by a periodontal clinician.

The working tip 105 includes a shank 107. The shank 107 includes a body 108 extending distally relative to the shaft 103. The overall shape of the body 108 of the shank 107 may be any one of many different shapes. For example, the overall shape of the body 108 of the shank 107 may be linear or straight, curved, angled, sickle-shaped, mini-sickle-shaped, Columbia-type, Gracey-type, Svärdström-type and/or combinations thereof so as to facilitate debridement of a root surface.

The body 108 includes or defines a plurality of blades adapted for use in debridement of a root surface. For example, and as specifically shown in FIG. 1, the plurality of blades defined by the body 108 includes a first blade 109 and a second blade 111. Each of the first and second blades (109 and 111) is adapted for use in debridement of a root surface. The shape of the body 108 of the shank 107 at the first blade 109 may be any one of many different shapes. For example, the shape of the body 108 of the shank 107 at the first blade 109 may be rounded, flat, uniformly thick, uniformly thin, graduated thickness, heavy-gauge, light-gauge and combinations thereof so as to facilitate scaling of a root surface. The shape of the body 108 of the shank 107 at the second blade 111 may be any one of many different shapes. For example, the shape of the body 108 of the shank 107 at the second blade 111 may be rounded, flat, uniformly thick, uniformly thin, graduated thickness, heavy-gauge, light-gauge and combinations thereof so as to facilitate planing of a root surface.

In one embodiment of the present invention the first blade 109 and the second blade 111 is dimensioned and configured differently from each other based on function. The first blade 109 is dimensioned and configured for relatively coarse scaling of a root surface wherein the second blade 111 is dimensioned and configured for relatively fine planing of a root surface.

One or both of the first blade 109 and the second blade 111 may be permanently attached or separate components. For example, the first blade 109 and the second blade 111 may be selectively installable and/or replaceable parts or components of the body 108, separate and distinct from other (e.g., non-blade) parts or portions of the body 108. In accordance with some such embodiments, the body 108 may be a single unit or may be made from multi-components.

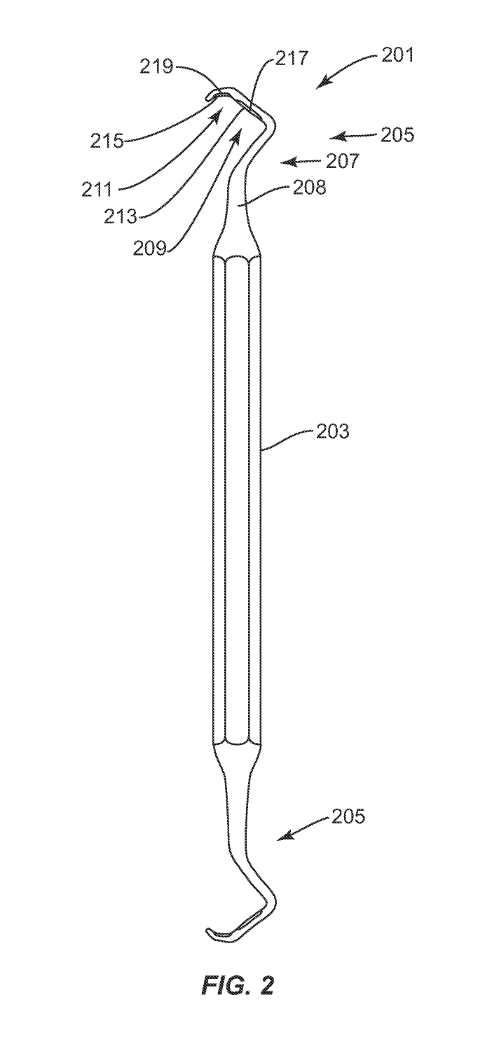

Additional exemplary embodiments of periodontal instruments, working tips adapted for use therewith, and tooth maps constructed in accordance with the present disclosure are illustrated in FIGS. 2, 3, 4, 5, 6, 7 and 8. Elements shown in any one of FIGS. 1-8 that structurally and/or functionally correspond to elements described herein with respect to any other one of FIGS. 1-8 have been designated by corresponding reference numerals increased or decreased, as the case may be, by one or more increments of one hundred. The embodiments and/or elements of any one of FIGS. 1-8 may be constructed in the same manner as the corresponding embodiments and/or elements of any other one of FIGS. 1-8 unless otherwise stated. Likewise, the embodiments and/or elements of any one of FIGS. 1-8 may operate in the same manner as the corresponding embodiments and/or elements of any other one of FIGS. 1-8 unless otherwise stated.

Referring now to FIG. 2, a periodontal instrument 201 is shown. The instrument 201 is adapted for use in debridement of a root surface of a tooth and includes a shaft 203 and a working tip 205 disposed at an end of the shaft 203. The shaft 203 is dimensioned and configured to facilitate manual manipulation of the working tip 205 by a periodontal clinician. For example, the shaft 203 defines an elongated handle ergonomically configured and dimensioned to facilitate hand manipulation of the instrument 201 by a clinician. As shown in FIG. 2, the shaft 203 defines a hexagonal shape in cross-section so as to facilitate manual grasping and manipulation of the instrument 201.

The working tip 205 includes a shank 207. The shank 207 includes a body 208 extending distally relative to the shaft 203. The body 208 includes or defines a plurality of blades adapted for use in debridement of a root surface. For example, and as specifically shown in FIG. 2, the plurality of blades defined by the body 208 includes a first blade 209 and a second blade 211. Each of the blades 209, 211 is adapted for use in debridement of a root surface and in some instances root surfaces of particular teeth. The orientation of the first blade 209 relative to a longitudinal axis of the shaft 203 may be any one of many orientations. For example, the orientation of the first blade 209 relative to a longitudinal axis of the shaft 203 may be substantially parallel to the longitudinal axis of the shaft 203, substantially perpendicular to the longitudinal axis of the shaft 203, and at an angle to the longitudinal axis of the shaft 103 to facilitate scaling of a root surface. The orientation of the second blade 211 relative to a longitudinal axis of the shaft 203 may be any one of many orientations. For example, the orientation of the second blade 211 relative to a longitudinal axis of the shaft 203 may be substantially parallel to the longitudinal axis of the shaft 203, substantially perpendicular to the longitudinal axis of the shaft 203, and at an angle to the longitudinal axis of the shaft 103 to facilitate planing of a root surface. The position of the first blade 209 along a length of the body 208 of the shank 207 may be any one of many positions. For example, the position of the first blade 209 along a length of the body 208 of the shank 207 may be substantially at an end of the body 208 proximate the shaft 203, substantially at an end of the body 208 distal the shaft 203, and at a middle portion of the body 208 between an end of the body 208 proximate the shaft 203 and an end of the body 208 distal the shaft 203 to facilitate scaling of a root surface. The position of the second blade 211 along a length of the body 208 of the shank 207 may be any one of many positions. For example, the position of the second blade 211 along a length of the body 208 of the shank 207 may be substantially at an end of the body 208 proximate the shaft 203, substantially at an end of the body 208 distal the shaft 203, and at a middle portion of the body 208 between an end of the body 208 proximate the shaft 203 and an end of the body 208 distal the shaft 203 to facilitate planing of a root surface.

The first blade 209 and the second blade 211 are dimensioned and configured differently from each other based on function. The first blade 209 includes or defines a first cutting edge 213 and is dimensioned and configured for relatively coarse scaling of a root surface. The shape of the first blade 209 may be any one of many different shapes. For example, the shape of the first blade 209 may be linear or straight, curved, relatively blunt, relatively fine, relatively short, relatively long and/or combinations thereof so as to facilitate root surface scaling. The second blade 211 includes or defines a second cutting edge 215 and is dimensioned and configured for fine planing of a root surface. The shape of the second blade 211 may be any one of many different shapes. For example, the shape of the second blade 211 may be linear or straight, curved, relatively blunt, relatively fine, relatively short, relatively long and combinations thereof so as to facilitate root surface planing. The shape of the first cutting edge 213 may be any one of many different shapes. For example, the shape of the first cutting edge 213 may be linear or straight, curved, convex, concave, continuous, intermittent, even, uneven, serrated and combinations thereof to facilitate scaling of a root surface. The shape of the second cutting edge 215 may be any one of many different shapes. For example, the shape of the second cutting edge 215 may be linear or straight, curved, convex, concave, continuous, intermittent, even, uneven, serrated and combinations thereof to facilitate planing of a root surface.

In a vicinity of the first blade 209, the shank 207 defines a first cross-sectional geometry dimensioned and configured to facilitate root surface scaling. In a vicinity of the second blade 211, the shank 207 defines a second cross-sectional geometry dimensioned and configured to facilitate relatively root surface planing.

The shank 207 includes a first facet 217 at least partially defining the first blade 209 and the first cutting edge 213 and a second facet 219 at least partially defining the second blade 211 and the second cutting edge 215. In the vicinity of the first facet 217, the shank 207 defines a first surface geometry characterized by contour, depth, angle, pitch, sharpness, smoothness, roughness and other relevant structural features so as to facilitate root surface scaling. The shape or surface geometry of the first facet 217 may be one of many different shapes or surface geometries. For example, the shape or surface geometry of the first facet 217 may be planar or flat, curved, convex, concave, smooth, scalloped, fluted, ridged and combinations thereof to facilitate scaling of a root surface. Similarly, in a vicinity of the second facet 219, the shank 207 defines a second surface geometry characterized by contour, depth, angle, pitch, sharpness, smoothness, roughness, and other relevant structural features so as to facilitate root surface planing. The shape or surface geometry of the second facet 219 may be one of many different shapes or surface geometries. For example, the shape or surface geometry of the second facet 219 may be planar or flat, curved, convex, concave, smooth, scalloped, fluted, ridged and combinations thereof to facilitate planing of a root surface. For purposes of the present disclosure, the term facet is defined to include a surface of a given blade leading up to the cutting edge thereof.

In order to facilitate manual manipulation by a clinician and to better position the tool to achieve the desired task, the body 208 and shank 207 can be straight, hooked, curved, semi-circular, bent or angled, etc. as needed to allow the clinician to position the tool in such a way in order to gain better access to the root surfaces of the tooth so as to facilitate scaling and planning of the root surface.

In one embodiment of the present invention, the first blade 209 is specifically configured and dimensioned for scaling at least one particular type of root surface selected from the group consisting of incisor root surface, a canine root surface, a premolar root surface, and a molar root surface. Similarly, the second blade 211 is specifically configured and dimensioned for planing the same or different particular type or types of root surface that the first blade 209 is specifically configured and dimensioned for scaling.

In yet another embodiment of the present invention, one or the other, or both, of the shaft 203 and the working tip 205 are color coded to facilitate instrument choice by a clinician for debridement of the particular type of root surface.

As also shown in FIG. 2, the instrument 201 may include a second instance of the working tip 205 disposed at another end of the shaft 203. One or the other or both of the shaft and the working tip of the second instance of the working tip 205 may be color coded to facilitate instrument choice by a clinician for debridement of at least one particular type of root surface. The first and second instances of the working tip 205 may be differently color coded in this regard, for example, based on at least slight differences in shank body or shank blade structure and/or root surface debridement function (e.g., relating to which particular type or types of root surface, for debridement of which the respective working tip may be specifically configured) as between the first instance of the working tip 205 and the second instance of the working tip 205.

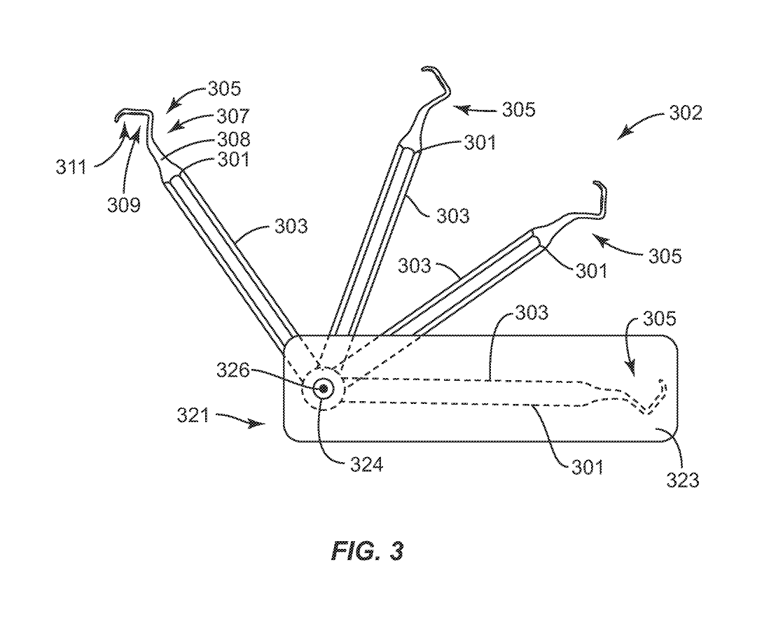

Turning now to FIG. 3, a periodontal tool 302 is shown. The tool 302 is adapted for use in debridement of a root surface of a tooth.

The tool 302 includes a periodontal instrument 301 having a shaft 303 and a working tip 305 disposed at an end of the shaft 303. The shaft 303 is dimensioned and configured to facilitate manual manipulation of the working tip 305 by a periodontal clinician. The working tip 205 includes a shank 307. The shank 307 includes a body 308 extending distally relative to the shaft 303. The body 308 includes or defines a first blade 309 and a second blade 311. Each of the first blade 309 and the second blade 311 are adapted for use in debridement of a root surface. That is, the first blade 309 and the second blade 311 is dimensioned and configured differently from each other based on function. For example, the first blade 309 may be dimensioned and configured for relatively coarse scaling of a root surface, while the second blade 311 may be dimensioned and configured for relatively fine planing of a root surface.

In one embodiment of the present invention, the tool 302 includes a plurality of periodontal instruments 301, each of which includes a working tip 305, and a shaft 303. For example, the tool 302 may include up to ten instruments housed in one housing. Each of the tools 303 may be used as a handle or each tool is configured with a handle for clinical manipulation. individually mounted directly to the housing 321 at the shaft 303 or other part of the tool. The housing 321 may be or define a handle for the tool 302. For example, the housing 321 may be compact, ergonomically designed, and/or manually manipulable by a clinician for purposes of utilizing the tool 302 for root surface debridement. The housing 321 may include walls 323 defining an enclosure sized and shaped to at least partially enclose any one or more or all of the periodontal instruments 301 within the housing 321 when the same are not in use by a clinician, and to permit each working tip 305 together with the corresponding shaft 303 to be selectively individually retractably deployed outward of the housing 321 for use by the clinician with such corresponding shaft 303 continuing to be mounted to the housing 321.

In one embodiment of the present invention, the housing 321 includes a hinge 324 within the enclosure to which each instrument is respectively coupled. That is, the hinge 324 defines an axis point 326 about which each periodontal instrument 301 rotates thereby be selectively retractably deployed outward of the housing 321 for use by the clinician.

The housing 321 may be configured and dimensioned to include at least one side through which each periodontal instrument 301 passes upon being deployed outward of, or retracted back into, the housing 321. For example, and as shown in FIG. 3, the housing 321 may include one (1) side 328 through which the periodontal instruments 301 pass outward of or into the housing 321. Other configurations are possible in this regard. For example, the periodontal tool 302 may include at least one or more additional pluralities of periodontal instruments (not shown) in addition to the plurality of periodontal instruments 301 shown in FIG. 3, and the housing 321 may be configured and dimensioned to include one or more additional sides (not shown) in addition to the one side 328, through which periodontal instruments pass in and out of the housing 321. In accordance with at least one embodiment of the present invention, the overall shape of the housing is selected from the group consisting of rectangular, square, circular, oblong etc. having at least one periodontal tool.

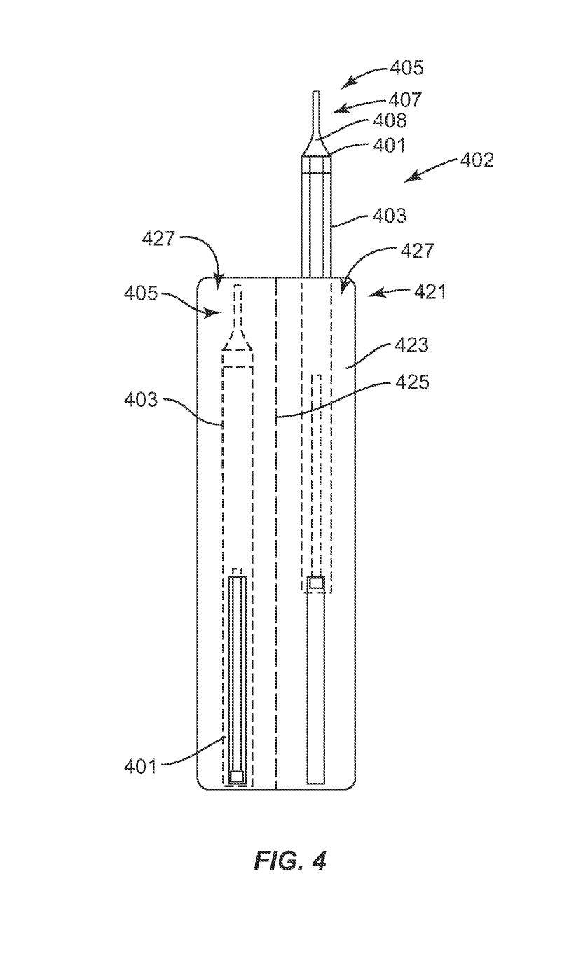

Turning now to FIG. 4, a periodontal tool 402 is shown. As with the tool 402 described in FIG. 3, the tool of FIG. 4 includes a plurality of periodontal instruments 401 arranged in a housing 421.

Each periodontal instrument includes a working tip 405 includes a shank 407 having a body 408. The body extends distally and relative to the shaft 403. The body 408 includes a first blade 409 (obscured) and a second blade 411 (obscured) each adapted for use in debridement of a root surface.

The first and second blades are configured differently from each other based on function. That is, the first blade 409 is configured for relatively coarse scaling of a root surface where the second blade 411 is configured for relatively fine planing of a root surface.

The housing 421 includes walls 423 configured to define an enclosure that is sized and shaped to at least partially enclose the periodontal instruments 401 within the housing 421 in such a way as to permit each instrument 401 to be selectively individually retractably deployed outward of the housing 421. This allows the clinician to select the particular tool to be used while the used tools remain within the housing 421.

The housing 421 includes a plurality of walls 425 defining at least one channel 427 within which the periodontal instruments 401 may be retained when selectively retractably deployed outward of the housing 421 for use by the clinician. Although the housing 421 is shown in FIG. 4 to include a wall or walls 425 defining a separate channel 427 corresponding to each periodontal instrument 401 slidably retained within the housing 421, the number of such channels 427 defined by the wall or walls 425 of the housing 421 may be one (1), in which case both of the periodontal instruments 401 may be slidably retained in the same channel (not specifically shown). Other configurations, including configurations of the housing 421 including three or more channels 427 respectively corresponding to separate periodontal instruments 401 (not specifically shown), are also possible.

The housing 421 may be a single molded structure having at least one periodontal instrument 401 that passes upon deployed outward of, or retracted back into, the housing 421. For example, and as shown in FIG. 4, the housing 421 may include one (1) side 428 through which the periodontal instruments 401 pass outward of or into the housing 421. Other configurations and shapes are possible in this regard. In particular, the number of periodontal instruments retained within the housing can range from 1 to about 10, preferably about 5.

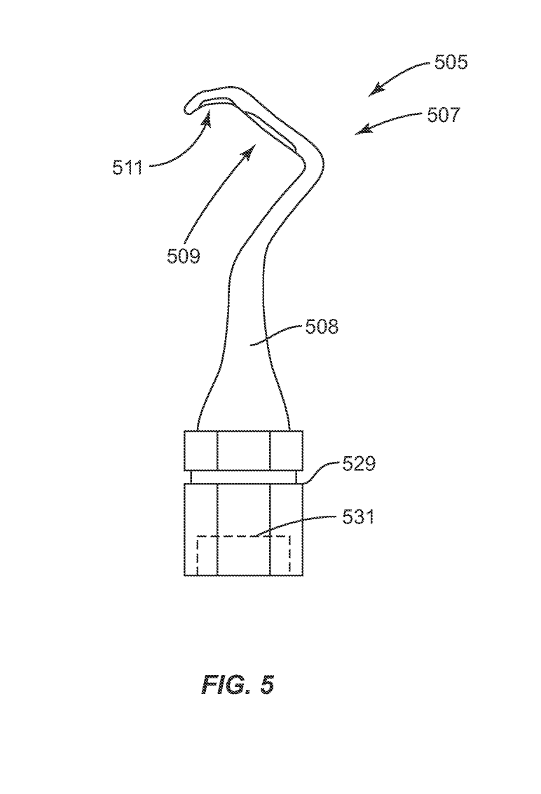

Referring now to FIG. 5, a working tip 505 is shown. The working tip 505 is adapted for use as a component of a periodontal instrument (not shown) adapted for use in debridement of a root surface of a tooth. The working tip 505 includes a shank 507, which includes a body 508. The body 508 is configured to include or define a first blade 509 and a second blade 511, each adapted for use in debridement of a root surface.

The first and second blades (509, 511) are configured differently from each other based on function. In one embodiment of the invention, the first blade 509 is dimensioned and configured for relatively coarse scaling of a root surface and the second blade 511 for relatively fine planing of a root surface.

In this embodiment of the present invention, the working tip 505 includes a coupling abutment 529 configured and dimensioned to selectively and releasably couple the working tip 505 to a handle (not separately shown) of the periodontal instrument (not shown). The body 508 of the shank 507 is disposed at an end of the coupling abutment 529 and extends distally relative thereto. The coupling abutment 529 can be coupled using a magnetized fastener and/or a selectively releasable quick-connect fastener.

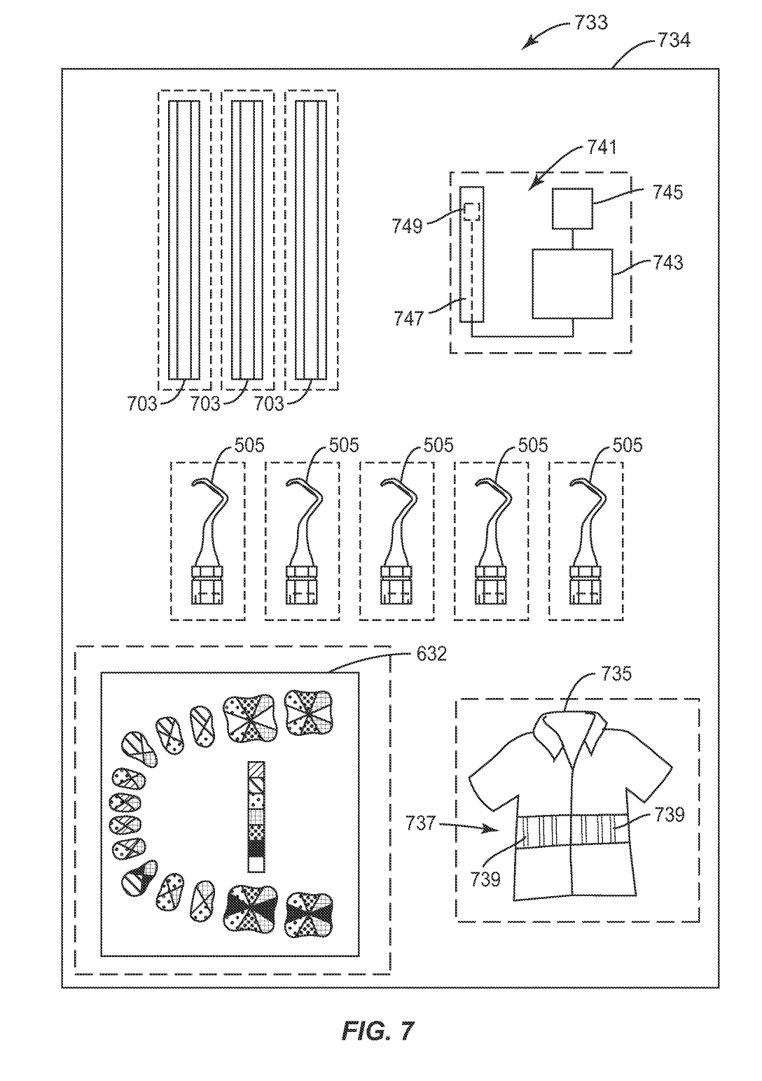

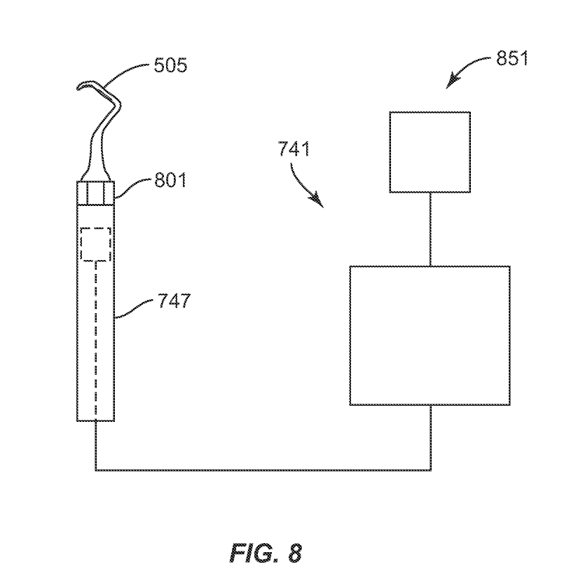

The coupling abutment 529 is configured and dimensioned to be selectively releasably coupled to at least one of an axially elongated shaft defining an ergonomically designed handle of a periodontal instrument configured for manual root surface debridement (not shown, see, e.g., FIG. 7). In one embodiment, the ergonomically designed handle or hand piece includes an ultrasonic driver configured for ultrasonic root surface debridement (not shown, see, e.g., FIGS. 7 and 8) in order to form a periodontal tool (not shown, see, e.g., FIG. 8) in accordance with the principles of the present disclosure. For example, the working tip 505 may include an element 531 (obscured by the coupling abutment 529) incorporated within an end of the coupling abutment 529 other than the end thereof at which the body 508 of the shank 507 is disposed. The element 531 may be a magnet or a magnetizable element allowing the coupling abutment 529 to function as a selectively releasable magnetized fastener, such as with respect to a handle of a periodontal hand instrument or a graspable hand piece including an ultrasonic driver. Alternatively, and/or in addition, the element 531 may be a quick connect feature allowing the coupling abutment to function as a selectively releasable quick-connect fastener, such as with respect to a handle of a periodontal instrument or a graspable hand piece including an ultrasonic driver. Joints (not shown) formed between the coupling abutment 529 and such handle or hand piece (not shown) may be self-lubricating for durability and ease of use.

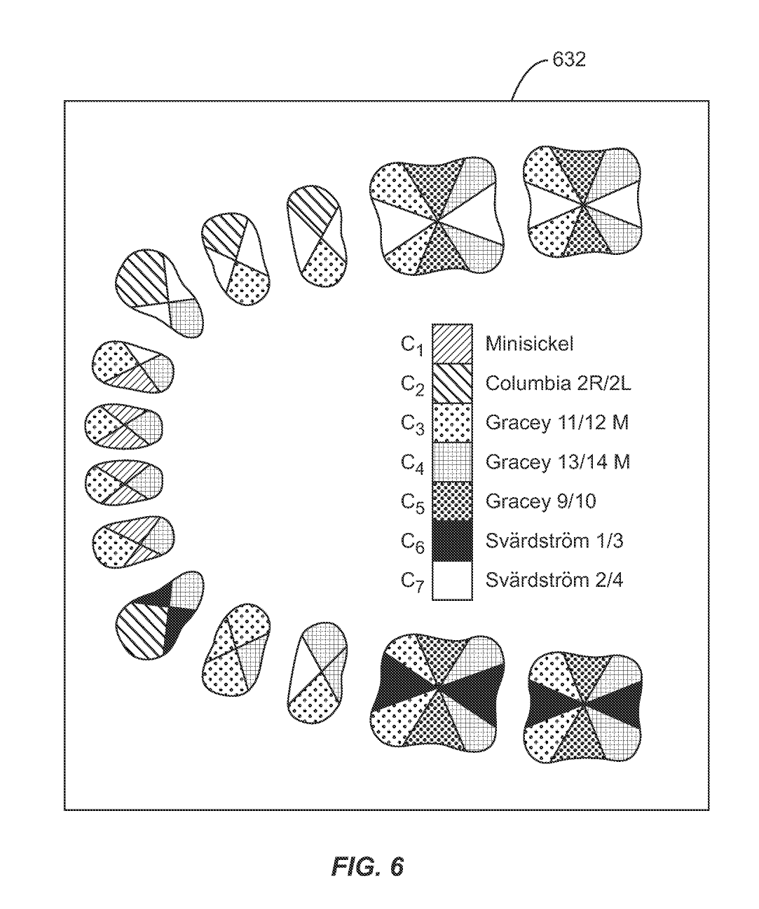

Turning now to FIG. 6, a tooth map 632 is shown. The tooth map 632 may be printed or otherwise appear on the surface of a flexible, wall-mountable panel or poster (not separately shown). The tooth map 632 may include color-coded illustrations indicating particular working tips (and/or periodontal instruments including such working tips) to be used for debriding corresponding particular types of root surfaces. For example, and as shown in FIG. 6, the color-coded illustrations of the tooth map 632 may indicate that: 1) a working tip having a mini-sickle configuration may be used to debride one or more root surfaces of an incisor; 2) a working tip having a Columbia 2R/2L configuration may be used to debride one or more root surfaces of a canine and one or more root surfaces of a premolar; 3) a working tip having a Gracey 11/12 M configuration may be used to debride one or more root surfaces of an incisor, one or more root surfaces of a premolar, and one or more root surfaces of a molar; 4) a working tip having a Gracey 13/14 M configuration may be used to debride one or more root surfaces of an incisor, one or more root surfaces of a canine, one or more root surfaces of a premolar, and one or more root surfaces of a molar; 5) a working tip having a Gracey 9/10 configuration may be used to debride one or more root surfaces of a molar; 6) a working tip having a Svärdström 1/3 configuration may be used to debride one or more root surfaces of a canine and one or more root surfaces of a molar; and 7) a working tip having a Svärdström 2/4 configuration may be used to debride one or more root surfaces of an incisor, one or more root surfaces of a canine, one or more root surfaces of a premolar, and one or more root surfaces of a molar.

Referring now to FIG. 7, a periodontal treatment kit 733 is shown. The treatment kit 733 may include a housing 734 to contain and retain kit components and may be equipped and configured for use in debridement of a root surface of a tooth.

The treatment kit 733 may include at least one of an axially elongated shaft 703. Each shaft 703 may define a graspable handle of a periodontal instrument (not separately shown) configured for root surface debridement. Each shaft 703 may be sterilized and individually packaged within the treatment kit 733 or can be sterilized on site.

The treatment kit 733 may include a plurality of working tips 505. For example, the working tip 505, preferably about 2-6 working tips. Each working tip 505 of the plurality thereof may be configured and dimensioned to be used for debridement of a different particular type of root surface, and may be color-coded accordingly. Each working tip 505 may be sterilized and individually packaged within the treatment kit 733.

The treatment kit 733 may include a tooth map 632. The tooth map 632 may be sterilized and individually packaged within the treatment kit 733.

In one embodiment of the invention, the treatment kit 733 may also include a clinician gown 735. The clinician gown may be an integrated clinician gown for a periodontal clinician. That is, a tool belt 737 may be integrated within the fabric of the clinician gown 735. For example, the fabric of the clinician gown 735 may include a plurality of pockets 739 configured and adapted to receiving and releasably retain periodontal instruments for use during a root surface debridement procedure. The clinician gown 735 may be sterilized and individually packaged within the treatment kit 733.

Yet another embodiment of the present invention is directed to a treatment kit 733 including an ultrasonic scaling system 741 configured and adapted to operate with the plurality of working tips 505. For example, the ultrasonic scaling system 741 may include a power supply 743, a foot control 745 electrically coupled to the power supply 743 and configured to control the same, and a hand piece 747 containing an ultrasonic driver 749 electrically coupled to the power supply 743. The hand piece 747 may be configured and dimensioned to individually receive and retain at an end thereof any one, or more, or each of the working tips 505 for purposes of forming a periodontal instrument (not specifically shown, see, e.g., FIG. 8) configured for root surface debridement. The ultrasonic scaling system 741 may be sterilized and individually packaged within the treatment kit 733.

Turning now to FIG. 8, which is directed to a periodontal tool 851 equipped and configured for root surface debridement. The tool 851 includes an ultrasonic root debridement system 741. The ultrasonic root debridement system 851 may further include an instance of a working tip 505 received and releasably retained at an end of the hand piece 747 of the ultrasonic root debridement system 741 to form a manually manipulable periodontal instrument 801.

In operation, the periodontal instruments of the present invention combines scaling and planing capabilities into one periodontal instrument in accordance with the present disclosure. The design of the periodontal instrument of the present invention are configured to facilitate rapid transition of one tip to the next for the clinician, reduces instrument space on the clinician's tray, and minimizes dropping of individual instruments when switching from treating one particular type of tooth to another particular type of tooth, or from one particular type of root surface to another particular type of root surface. Mounting multiple periodontal instruments together in a common housing of a periodontal tool 302, 402 in accordance with the present disclosure allows a variety of combinations of multiple periodontal instruments speeds procedure completion and reduces instrument space on the clinician's tray.

The periodontal instruments of the present invention are configured for easy cleaning using different sterilization techniques including autoclaving the device and plurality of working tips. Color-coding of the various periodontal instruments and/or working tips and/or shafts or handles of the present invention in accordance with the present disclosure speeds instrument choice. The tooth map 632 disclosed herein may be posted on and/or adhered to an office wall for ease of use and reference by a clinician during a given procedure. As discussed above, the clinician gown 735 disclosed herein may be equipped with a tool belt 737 for storage and retrieval of periodontal instruments and tools described herein, and may be worn by a clinician during a given procedure, affording the clinician improved access to needed instruments and tools while also speeding the process of switching between and among such tools as needed to treat a wide variety of different particular types of teeth and root surfaces thereof.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A periodontal instrument adapted for use in debridement of a root surface of a tooth, the periodontal instrument comprising:
an axially elongated shaft; and
a shank disposed at an end of the shaft, the shank having a body extending distally relative to the shaft, the body including a plurality of blades adapted for use in debridement of a root surface, the plurality of blades including at least a first blade configured for scaling of a root surface, and a second blade configured for planing of a root surface, the first and second blades each comprising a first surface and an opposite second surface that converge to define a cutting edge;
wherein the shaft is dimensioned and configured to facilitate manual manipulation of the shank.

2. A periodontal instrument as recited in claim 1, wherein the overall shape of the body of the shank is selected from the group consisting of linear or straight, curved, angled, sickle-shaped, mini-sickle-shaped, Columbia-type, Gracey-type, Svärdström-type and combinations thereof so as to facilitate debridement of a root surface.

3. A periodontal instrument as recited in claim 1, wherein at the first blade, the shape of the body of the shank is selected from the group consisting of rounded, flat, uniformly thick, uniformly thin, graduated thickness, heavy-gauge, light-gauge and combinations thereof so as to facilitate scaling of a root surface, and at the second blade, the shape of the body of the shank selected from the group consisting of rounded, flat, uniformly thick, uniformly thin, graduate thickness, heavy-gauge, light-gauge and combinations thereof so as to facilitate planing of a root surface.

4. A periodontal instrument as recited in claim 1, wherein the shape of the first blade is selected from the group consisting of linear or straight, curved, relatively blunt, relatively fine, relatively short, relatively long and combinations thereof to facilitate scaling of a root surface, and the shape of the second blade is selected from the group comprising linear or straight, curved, relatively blunt, relatively fine, relatively short, relatively long and combinations thereof to facilitate planing of a root surface.

5. A periodontal instrument as recited in claim 1, wherein the first blade defines a first cutting edge having a shape selected from the group consisting of linear or straight, curved, convex, concave, continuous, intermittent, even, uneven, serrated and combinations thereof to facilitate scaling of a root surface, and the second blade defines a second cutting edge having a shape selected from the group comprising linear or straight, curved, convex, concave, continuous, intermittent, even, uneven, serrated and combinations thereof to facilitate planing of a root surface.

6. A periodontal instrument as recited in claim 5, wherein immediately adjacent to the first cutting edge, the first blade defines at least a first facet having a shape selected from the group consisting of planar or flat, curved, convex, concave, smooth, scalloped, fluted, ridged and combinations thereof to facilitate scaling of a root surface, and immediately adjacent to the second cutting edge, the second blade defines at least a second facet having a shape selected from the group consisting of planar or flat, curved, convex, concave, smooth, scalloped, fluted, ridged, and combinations thereof to facilitate planing of a root surface.

7. A periodontal instrument as recited in claim 1, wherein a position of the first blade along a length of the body of the shank is selected from the group consisting of substantially at an end of the body proximate the shaft, substantially at an end of the body distal the shaft, and at a middle portion of the body between an end of the body proximate the shaft and an end of the body distal the shaft to facilitate scaling of a root surface, and a position of the second blade along a length of the body of the shank is selected from the group comprising substantially at an end of the body proximate the shaft, substantially at an end of the body distal the shaft, and at a middle portion of the body between an end of the body proximate the shaft and an end of the body distal the shaft to facilitate planing of a root surface.

8. A periodontal instrument as recited in claim 1, wherein an orientation of the first blade relative an axis of the shaft is selected from the group comprising substantially parallel to the axis of the shaft, substantially perpendicular to the axis of the shaft, and at an angle to the axis of the shaft to facilitate scaling of a root surface, and an orientation of the second blade relative to an axis of the shaft is selected from the group comprising substantially parallel to the axis of the shaft, substantially perpendicular to the axis of the shaft, and at an angle to the axis of the shaft to facilitate planing of a root surface.

9. A periodontal instrument as recited in claim 1, wherein the first blade is configured for scaling at least one particular type of root surface selected from the group consisting of an incisor root surface, a canine root surface, a premolar root surface, and a molar root surface, and the second blade is configured for planing the at least one particular type of root surface.

10. A periodontal instrument as recited in claim 1, wherein at least one of the shaft and the shank is color-coded.

11. A periodontal instrument as recited in claim 1, wherein the shaft includes a handle configured and dimensioned to facilitate manual manipulation by a clinician.

12. A periodontal instrument as recited in claim 2, further comprising a second shank disposed at another end of the shaft and extending distally relative thereto, the second shank defining a plurality of blades adapted for use in debridement of a root surface, the plurality of blades including at least a third blade configured for scaling of a root surface, and a fourth blade configured for planing of a root surface.

13. A periodontal tool adapted to facilitate debridement of a variety of different types of root surfaces, comprising:
walls defining a housing; and
a plurality of periodontal instruments disposed within the housing, each periodontal instrument of the plurality of periodontal instruments including an axially elongated shaft and a shank disposed at an end of the shaft and extending distally relative thereto, the shank defining a plurality of blades adapted for use in debridement of a root surface, the plurality of blades at least including a first blade configured for scaling of a root surface and a second blade configured for planing of a root surface, wherein the respective shanks of the periodontal instruments have different configurations from each other so as to facilitate debridement of different types of root surfaces selected from the group comprising an incisor root surface, a canine root surface, a premolar root surface, and a molar root surface.

14. A periodontal tool as recited in claim 13, wherein each of the shafts of the plurality of periodontal instruments is individually mounted to the housing and is interoperable therewith such that the periodontal tool is configured to permit the shank of each periodontal instrument of the plurality thereof to be selectively individually retractably deployed outward of the housing for use by a clinician.

15. A periodontal tool as recited in claim 14, further comprising a hinge defining an axis point in the housing and connecting the shaft of each periodontal instrument of the plurality thereof to said housing so that the shaft rotates about the axis point and the corresponding shank retractably rotates outward of the housing for use by the clinician.

16. A periodontal tool as recited in claim 14, wherein the housing includes walls defining at least two channels within which the periodontal instruments of the plurality thereof are disposed so that each shank thereof retractably slides outward of the housing for use by the clinician.

17. A working tip for a periodontal instrument adapted for use in debridement of a root surface of a tooth, the working tip comprising:
a releasable coupling abutment configured so that said working tip is attachable to a handle of the periodontal instrument; and
a shank disposed at an end of the coupling abutment, the shank including a body extending distally relative to the coupling abutment, the body defining a plurality of blades adapted for use in debridement of a root surface, the plurality of blades including at least a first blade configured for scaling a root surface, and a second blade configured for planing a root surface.

18. A working tip as recited in claim 17, wherein at least a portion of the coupling abutment is a magnetized or magnetizable fastener, and/or is configured with a releasable quick-connect fastener for attachment to said handle.

19. A periodontal treatment kit equipped and configured for use by a clinician in debridement of a root surface of a tooth, the kit comprising at least two working tips according to claim 17, wherein the respective shanks of the working tips are configured differently from each other so as to facilitate debridement of different respective particular types of root surfaces selected from the group consisting of an incisor root surface, a canine root surface, a premolar root surface, and a molar root surface.

20. A periodontal treatment kit as recited in claim 19, further comprising at least one of an axially elongated shaft defining a handle for a periodontal instrument configured for root surface debridement.

21. A periodontal treatment kit as recited in claim 20, wherein the handle includes an ultrasonic driver configured for ultrasonic root surface debridement.

22. A periodontal treatment kit as recited in claim 19, further comprising a wall-mountable, color-coded tooth map containing illustrations indicating particular working tips to be used for debriding corresponding particular types of root surfaces, wherein each working tip of the at least two working tips is color-coded accordingly.

23. A periodontal treatment kit as recited in claim 19, further comprising an integrated periodontal clinician gown including a tool belt-style feature defining a plurality of pockets for receiving and releasably retaining periodontal instruments for use during a root surface debridement procedure.
